(19) United States
(12) Patent Application Publication
(10) Pub. No.: US 2025/0232536 A1
(43) Pub. Date: Jul. 17, 2025

(54) INTEGRATING EXTERNAL MESSAGES IN AN AUGMENTED REALITY ENVIRONMENT

(71) Applicant: PICTORYTALE AS, KRISTIANSAND (NO)

(72) Inventors: Suraj PRABHAKARAN, Aachen (DE); Håkon GUNDERSEN, Oslo (NO); Gokce ATAMAN, Oslo (NO)

(21) Appl. No.: 18/849,380

(22) PCT Filed: Mar. 20, 2023
(86) PCT No.: PCT/NO2023/050061

§ 371 Date: Sep. 20, 2024

(30) Foreign Application Priority Data
Mar. 21, 2022 (NO) 20220340

(51) Int. Cl. G06T 19/00; G06T 19/20; G06V 20/20

(52) U.S. Cl. CPC G06T 19/006; G06T 19/20; G06V 20/20; G06T 2219/2004

(57) ABSTRACT

A method in a computing device of providing an external message in an augmented reality environment. An external message including metadata relating to the desired presentation of the external message in the augmented reality environment is received in a device. The device analyzes the message and determines parameters for integration defined in metadata. The message is integrated into the augmented reality environment based on a comparison of characteristics of the augmented reality environment with the metadata relating to the desired presentation of the external message in the augmented reality environment. The augmented reality environment is then rendered with the external message integrated into the augmented reality environment.

### TECHNICAL FIELD

The present invention relates to methods and systems for integrating messages such as advertisements into augmented reality content in a manner that does not disrupt the augmented reality scene.

### BACKGROUND

It has become common to present messages such as advertisements, announcements, and the like in the form of banners, videos, notifications, in-play content in the form of pictures, videos, or logos, etc. that are integrated into app presentations. Developers of mobile apps connect their apps to advertising networks such as Google AdMob, Unity Ads, etc. such that messages provided by the advertising network can be downloaded to a device and presented inside the app. This is done by using software development kits (SDKs) provided by the operator of the advertising network to integrate advertising modules into the mobile app. These modules include the necessary application programming interfaces (APIs) to communicate with the advertising network to receive messages and to forward the received messages to the mobile app to be presented alongside the native app content.

The app developers do not have to consider ad delivery decisions, i.e., the decisions made by the network regarding which messages to deliver to a specific instance of a given app at a given time. Instead, the advertising module may provide available context information such as the type of host app, position of the device, demographic information relating to the user and so on—possibly taking user configuration, legal limitations and the like into consideration—and the advertising network may select among messages intended to be presented in the context defined by the provided context information.

When this type of external messages is presented in apps for so called augmented reality (AR), the external messages are still presented in the same format as in traditional 2D app screens. AR can briefly be defined as presentation of virtual content alongside (e.g., superimposed) on a real-world environment, for example on goggles or glasses, heads up displays, or on the screed of a mobile phone which also displays a video presentation of the environment on the other side of the phone. When a traditional 2D message is presented as a banner on a screen or display that otherwise displays a real, 3D scene (including for these purposes a 2D video of a 3D scene within which the device is present), the result is that the immersive experience of the AR scene is disrupted. The situation is, of course, even worse if the AR presentation is disrupted and the entire scene is temporarily replaced by a presentation of a 2D advertisement.

Consequently, there is a need for methods and systems that are able to integrate messages into AR content in a manner that is not disruptive, but instead is experienced as natural by the user. In other words, the user should experience the message as belonging naturally in the AR scene as part of the augmented reality presentation.

### SUMMARY OF THE DISCLOSURE

The present invention addresses the needs outlined above by providing a method in a computing device of providing an external message in an augmented reality environment. The method includes receiving the external message including metadata relating to the desired presentation of the external message in the augmented reality environment, integrating the external message into the augmented reality environment based on a comparison of characteristics of the augmented reality environment with the metadata relating to the desired presentation of the external message in the augmented reality environment; and rendering the augmented reality environment with the external message integrated into the augmented reality environment. The metadata relating to the presentation of the external message in the augmented reality environment includes technical criteria for integration of the external message into the augmented reality environment.

The metadata relating to the desired presentation of the external message is evaluated for completeness with respect to integration, and if it is determined that the metadata is incomplete, for example that the message does not specify how it should be positioned or rendered in the AR scene in desired detail, it is determined whether the available metadata is sufficient for integration as it is. If the available metadata is sufficient for integration, even though the message may not provide an optimal user experience, it is integrated into the augmented reality environment based on the available information. If the available metadata is insufficient for integration, a process of surface detection is performed on the augmented reality environment and integration of the external message is performed based on its results, by positioning the message in conjunction with a detected surface in the augmented reality environment.

The technical criteria for integration may specify at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment.

Some embodiments of the invention include transmitting context information to a remote message server. The step of receiving the external message may then include receiving a set of messages that have been selected based on a comparison of the transmitted context information with selection criteria associated with the respective external messages and adding the received messages to local storage.

In the device, the external message to be integrated into the augmented reality environment may be selected from the set of messages based on prioritization according to a predetermined scoring system for prioritization of messages.

The metadata relating to the presentation of the external message in the augmented reality environment may in some embodiments include selection criteria specifying at least one of information about loaded augmented reality content, a feature detected in the augmented reality environment, a device location, and a user demographic.

Messages that are not initially intended for presentation in an AR environment may be adapted for such presentation by in a server configured to determine if the message is pure text, and if it is, converting the text to an image; determining if the message is an image, and if it is, generating and embedding metadata describing how the image should be integrated into an augmented reality environment; determining if the message is a video, and if it is, generating and embedding metadata describing how the image should be integrated into an augmented reality environment; and storing or transmitting the message as an external augmented reality message.

The metadata describing how the image should be integrated into an augmented reality environment includes technical criteria specifying at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment

Some embodiments may further comprise embedding metadata relating to the selection of the external message for integration in the augmented reality environment, including selection criteria specifying at least one of information about loaded augmented reality content, a feature detected in the augmented reality environment, a device location, and a user demographic.

In another aspect of the invention a device is configured to present an augmented reality environment and including an augmented reality app module configured to receive external messages, a camera module configured to receive image information relating to a local scene from a device camera, and an augmented reality content integration module configured to create an augmented reality environment by receiving and integrating images from the camera module, main augmented reality content from local memory, and external messages from the augmented reality app module.

The augmented reality integration module is configured to integrate the external messages into the augmented reality environment based on metadata associated with the respective messages and including technical criteria for integration of the external message into the augmented reality environment. The augmented reality app module is configured to evaluate the metadata relating to the presentation of the external message for completeness with respect to integration. It is further configured to, If it determines that the metadata is incomplete, determine whether the available metadata is sufficient for integration, and
if the available metadata is sufficient for integration, to integrate the external message into the augmented reality environment based on the available information, and
if the available metadata is insufficient for integration, to integrate the external message into the augmented reality environment based on a process of surface detection (507) in the augmented reality environment and integration of the external message in conjunction with a detected surface in the augmented reality environment.

The technical criteria for integration may specify at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment.

The device may be configured to receive main augmented reality content from an augmented reality content service and external messages from a message service.

### BRIEF DESCRIPTION OF THE DRAWINGS

The invention will now be described with reference to the drawings, where

FIG. 1 is an example of an augmented reality scene with an integrated external message;

FIG. 2 is a system that may be configured to operate in accordance with the invention;

FIG. 3 is a block diagram showing a device according to an embodiment of the invention;

FIG. 4 is a flowchart of a process performed on a device according to an embodiment of the invention;

FIG. 5 is a flowchart of a process performed on a device when selecting and integrating external messages in accordance with an embodiment of the invention; and

FIG. 6 is a flowchart of process performed on a server preparing external messages for distribution to and integration in augmented reality environments in accordance with an embodiment of the invention.

### DETAILED DESCRIPTION

Augmented reality apps are quite sophisticated compared to traditional 2D apps with respect to presentation of content. Some AR apps also provide 2D content, such as for example tags, gridlines, directions, measurement values and the like superimposed on a 2D or 3D view, but 3D AR content is becoming more and more popular. In order to integrate 3D AR content seamlessly into a scene the AR content should not only be positioned correctly in the view, but also in a manner that maintains the 3D aspects of the elements that are introduced. Hereinbelow 3D elements will include elements that are rendered in 2D on a display together with a 2D video rendering of the real environment, but in a manner where the 3D nature of the element is maintained for example in perspective, texture, shadow, and other aspects.

Such 3D AR content is typically experienced by activating the camera on a device such as a mobile phone, detecting the environment (such as a plain surface, or object of interest through image recognition, etc.) and placing the AR content in the scene in accordance with the detected features of the environment. For example, a user could place a 3D dancing character as an AR element in the user's living room and enjoy the experience. Or a user could bring up the phone camera in front of her face and see AR eye-glasses superimposed on the representation of her face, the eye-glasses being positioned based on face recognition software.

If such a presentation is interrupted by an in-app message such as an advertisement, for example when an in-app ad video commercial interrupts the user while the user is watching the dancing 3D character, the user may have to hold the phone still during the entire video presentation in order to ensure that when the presentation is over, the 3D AR content can continue correctly. If the user moves the phone during the presentation of the 2D video ad, while the camera is temporarily deactivated, there is a chance of the environment data being corrupted. In addition to this technical disruption, being interrupted and having to watch a 2D video while experiencing AR content in 3D is inconvenient and probably annoying to most users.

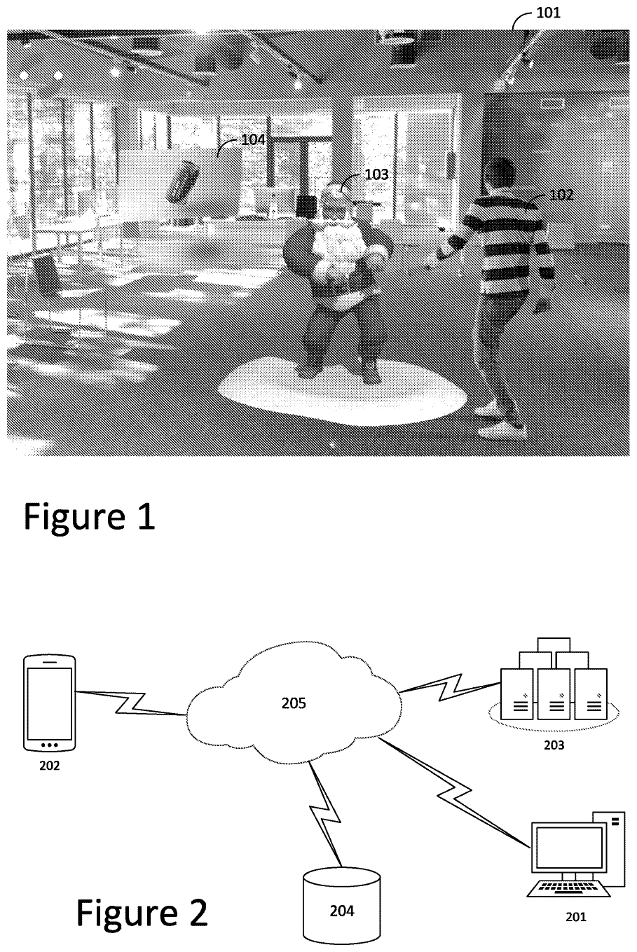

The present invention provides methods and systems for integrating AR messages, referred to herein as external AR messages, into other AR content in a manner that is not disruptive but instead allows users to experience the external AR messages in AR format consistent with the main AR experience and thereby also allows advertisers and others to create external AR messages that allow themselves to be integrated in an easy way. Instead of experiencing 2D video ads that take up the entire screen or 2D banners that are simply overlaid a part of the 3D AR presentation, users will experience the ads as side content in AR in addition to the main AR content. For example, FIG. 1 shows an exemplary AR scene where a user the user is watching an augmented environment 101 where a real person 102 is dancing with a 3D dancing Santa Claus 103 content (main AR content). At the same time an advertisement for a soft drink is presented to the user as a 3D board 104 displaying information related to the soft drink as side content to the side of the main content 103. Thus, the user experiences the external AR message along with the main AR content 103 in the AR environment 101 in a non-intrusive way, making the user experience smooth.

The main module provided by the invention is an AR app module which is integrated into the AR app by an app developer. The AR app may be developed on a computer 201 which includes the necessary tools for app development and also may include a software development kit (SDK) consistent with the present invention. The SDK may include tools and software modules or libraries that allow the AR app module to be integrated into the main AR app. After the main AR app has been developed it may be provided to users, for example through an app store, and users may install the AR app on a device such as a mobile phone 202. The main AR app may now be able to access main AR content from servers 203 and this content is integrated into an AR environment such as for example the Santa Claus 103 is integrated into the AR environment 101 in FIG. 1.

As already mentioned, the AR app module is integrated into the main AR app and thus installed on the device 202 together with the main AR app. In parallel with the main AR app's integration of the main AR content into the AR environment, the AR app module may contact an external AR message repository 204 to request an external AR message. When the external AR message is received it may be forwarded by the AR app module to the main AR app over an API and the main AR app can integrate the external AR message into the AR environment such as the soft drink information board 104 is integrated into AR environment 101 in FIG. 1.

The various devices and computers shown in FIG. 2 may be configured to communicate with each other over a computer network 205 which may be, or include, a wide area network such as the Internet.

By providing the necessary APIs and the requirements for external AR message formatting and placement, the invention allows external AR messages such as ads and announcements to be easily created, distributed, and displayed to users of any mobile app that integrates the AR app module.

It should be noted that this solution is not limited to AR apps that only play pre-defined AR content such as 3D characters or 2D AR filters. Embodiments of the invention may also provide external AP messages to AR games and other interactive environments as well. Furthermore, the external AR messages are not limited to static presentation but may include active elements and thus allow interaction and call for action.

Embodiments of the invention may be configured to handle various AR formats, some of which represent rich content that are developed with AR in mind. Examples of such content include 3D AR characters performing actions in the AR environment, for example mascots, logos, cartoon characters and the like, as well as animated or static 3D AR objects such as burgers, soft drink bottles, automobiles, and so on. A 3D object may also be a 3D board with the appearance of a billboard, a TV-set, or the like. This board may receive and display a 2D video message, thus providing integration of external messages originally developed for 2D media into the 3D AR environment, complete with the board as a rationale for the presence of the presentation. The size, position, and perspective of the 2D presentation will be dictated by the boards relative position to the viewer in the scene.

Other content may have been developed for 2D but placed into a 3D AR environment rather than being allowed to take over the entire display while it is being presented. A 2D video may, for example, be positioned as a floating image next to another AR object, such as the soft drink presentation 104 next to Santa Claus 103 in FIG. 1. This is similar to the billboard described above, except that there is no representation of a board or screen that provides a rationale for the presence of the 2D image. Instead, the image appears to be floating in the air, but it still has a defined position and orientation and is viewed from an angle determined by position relative to the user.

2D AR images or filters, animated or static, may especially be used when the AR app uses image recognition to introduce AR elements. For example, if the AR app uses face recognition to show filters such as AR sunglasses, the AR app module may flash additional sunglasses accessories as 2D images in AR.

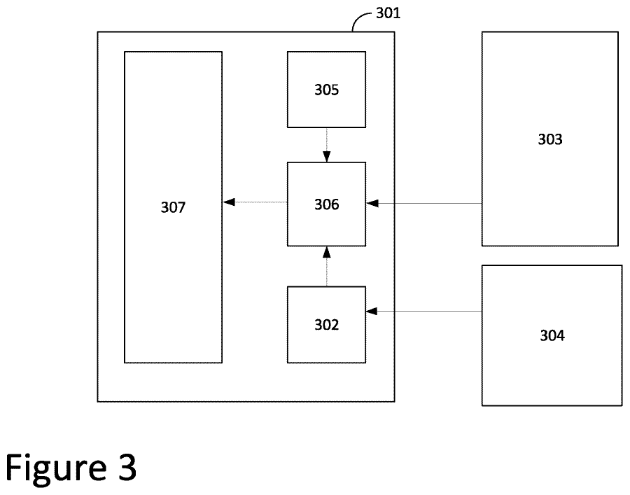

With AR app module integrated into the main AR app, the main AR app is able to present external AR messages to the user along with the main AR content. FIG. 3 shows in a block diagram how an embodiment of the invention may be configured and operate. The main AR app 301, which is installed on device 202, includes a number of modules, one of which is the AR app module 302. The main AR app 301 obtains main AR content from a service 303 running on a server 203, while the AR app module 302 obtains external AR messages from a message service 304 running on an external AR message repository 204.

The main AR app 301 may also include a camera module 305 which is configured to access, control, and obtain images from a camera that is part of the device 202. The images from the camera are provided by the camera module 305 to an AR integration module which also receives main AR content that has been provided by the AR content service 303 as well as external AR messages provided over an API from the AR app module 302. Communication with the services 303, 304 may be over the network 205.

The environment and the AR content is integrated into an AR environment representation in the AR content integrator 306 from which it may be provided to an AR renderer 307 which may be configured to control a display on the device 202.

The AR app module 302 includes endpoints that the developer of the main AR app can use to provide information and callbacks indicating that an AR presentation has been initiated along with information on how the user will be experiencing the AR content. This may for example be information on whether the main AR app will use surface detection, image recognition, etc. This way, when a user accesses AR content, the AR app module will know which means and format the external AR messages should have in order to display correctly together with the main AR content. For example, if surface detection will be used for showing the main AR content, such as a dancing 3D Santa Claus, the AR app module will use the same surface detection information in order to place a 3D external AR message in a non-intrusive way to the user.

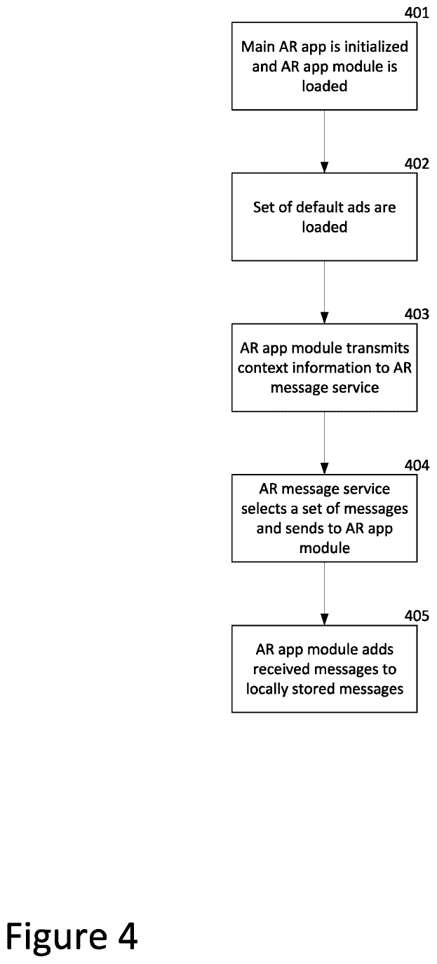

Reference is now made to FIG. 4 which is a flowchart illustrating the interaction between the main AR app 301, the AR app module 302 and the external AR message service 304. In a first step 401 the main AR app 301 is initialized, and this includes loading of the AR app module 302. The main AR app 301 may also, in some embodiments, provide information to the AR app module 302 about any AR content loaded from the AR content service 303, or any specific features detected or recognized in the images provided by the camera module 305. Such information may, of course, change while the app is running, for example because the user points the camera in a new direction or requests new content from the AR content service 303. In that case updated information may, in at least some embodiments of the invention, be provided to the AR app module 302.

In a next step 402 the AR app module 302 loads a set of default external AR messages which are already present on the device 202. This ensures that the AR app module 302 is able to serve external AR messages even in the absence of a connection with the external AR message service 304.

The AR app module 302 will also, in step 403, transmit context information to the external AR message service 304. This context information may vary in different embodiments, but may include the position of the device, demographic information about the user, message preferences configured by the user, a user ID for the user (which may be used to access a user profile already available to the external AR message service 304), information about the main AR app 301, and information about AR content loaded by the main AR app 301 or features or objects detected in the images obtained from the device camera.

In step 404 the AR message service compares the received context information with selection criteria defined for the various external AR messages stored in its database 204 and selects a set of messages with criteria fulfilled by the context information. This set of messages may then be sent to the AR app module 302. The AR app module 302, upon receiving the selected external AR messages, will add 405 the received external AR messages to the default messages and any other locally stored messages that may have been previously downloaded and makes all locally stored external AR messages available from integration in AR environments.

It will be understood that while the flowchart in FIG. 4 for practical reasons illustrate a step-by-step process where each step follows after another, embodiments of the invention running on a physical device will not necessarily operate in this strict manner. For example, the step of sending context information to the external AR messages service 304 may be performed whether or not the set of default messages has finished loading. Similarly, the context information may be retransmitted if it changes while the app 301 is running, which may result in new messages being selected by the external AR messages service 304 and transmitted to the AR app module 302. As such, the various steps may be implemented as routines that are called when certain events occur, and these routines are then executed until they can be completed.

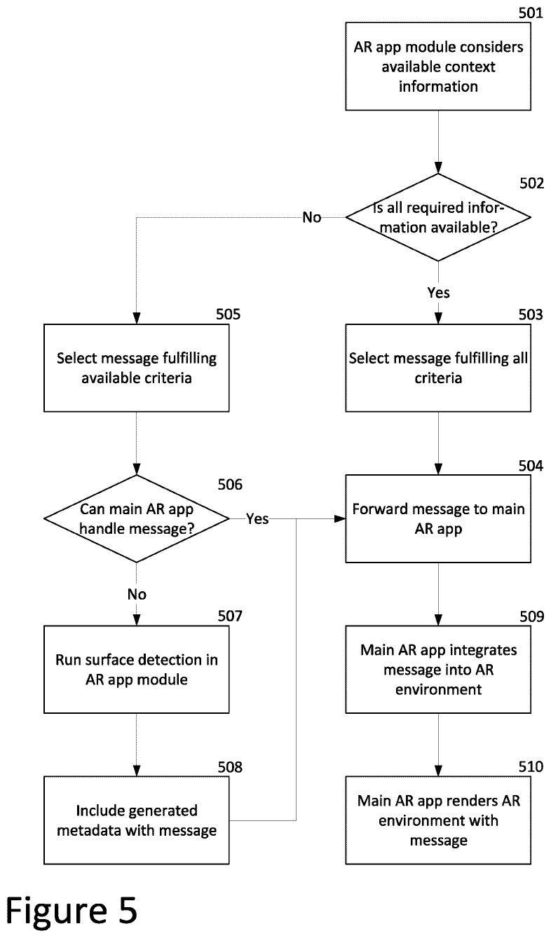

Turning now to FIG. 5, a description will be given of a process of selecting a specific external AR message from the locally available messages and integrating that message into an AR environment. As described above the external AR messages selected by the external AR message service 304 are selected because their criteria are fulfilled by the context information. However, some embodiments may include methods of prioritizing available messages. This means that in a first step 501 the AR app module selects one of the external AR messages that are available from local storage, and that this may be done based on prioritization. Prioritization may be based on a scoring system associated with how well the context information matches the selection criteria of each external AR message. For example, being associated with a feature detected in the scene may give a higher score than device location, and device location may give a higher score than user demographic. Various methods of prioritizing messages are known in the art and will not be discussed further, since this is merely a question of selecting criteria and scoring systems based on perceived importance (or willingness to pay for exposure).

However, some embodiments may also implement other selection criteria, for example by prioritizing sophisticated 3D AR messages over 2D video or banner presentations, or prioritizing (or strictly selecting) based on how the content integrates into the AR environment, for example based on surface detection or image recognition.

This means that the selection made in step 501 may include criteria provided as meta data together with the external AR message, the type of the external AR message, local context information and AR environment information provided by the main AR app 301, and metadata or data type information provided together with AR content loaded from the AR content service 303. Various embodiments of the invention may thus implement different capabilities in terms of APIs. If the main AR app 301 is configured to be able to load AR content from the AR content service 303, the AR app module may be configured to provide endpoints where the information about loaded AR content can be provided to the AR app module. This information may be forwarded to the external AR message service 304 as described above, and also be used locally to select one of several available external AR messages. For example, if the user activates an AR tour guide of the Eiffel Tower in Paris, this meta data can be transferred to the AR app module 302 (or in some embodiments it may have been included in the AR app module 302 when it was integrated into the main AR app 301 using the SDK), and AR app module 302 will in turn forward it to the external AR service 304. Based on this the external AR message service 304 may select a set of messages relating to restaurants, cafeterias, and bars near the Eiffel Tower, and from these the AR app module 302 may select an external AR message including a 3D representation of a sandwich which advertises a famous sandwich shop near the Eiffel Tower.

It should be noted that some embodiments may not implement local storage of a set of messages. In such embodiments there may be no selections made by the AR app module 302. Instead, the external AR message service 304 selects only one message and this message is sent to the device. This means that some steps described as being performed by the AR app module 302 are instead performed by the external AR message service 304.

In some situations, required metadata or context information may be missing. This may be the case if, for example, the developer of the main AR app 301 has neglected to include this information when configuring the main AR app 301, or that metadata is missing from the loaded AR content. In this context, all required information means all information that enables the AR app module 302 to select a message with selection criteria that are fulfilled by the context information, and that otherwise includes metadata that enables the AR app module 302 to conclude that the main AR app 301 will be able to integrate the external AR message correctly into the AR environment. This means that message format, methodology (such as surface detection or image recognition), and any other required information (which may vary by embodiment, by content, and by context) are compatible with the main AR app 301 and any loaded content.

If the AR app module 302 concludes, in step 502 that this is the case (i.e. that at least one compatible message is available) the process moves to step 503 where a message that does fulfill all requirements is selected. The process then moves to step 504 where the selected external AR message is forwarded to the main AR app 301.

If it is determined in step 502 that all required information is not available, the process instead moves to step 505 where a message fulfilling available criteria is selected. This means that it is determined in step 502 that some criteria may not be fulfilled, i.e., that there are no available messages for which all selection criteria are fulfilled by context information and all technical information is available and compatible. Either some information is missing, in which case it may not be known whether the external AR message is compatible with the main AR app 301 and other loaded AR content, or it can be determined that some criteria cannot be fulfilled. The latter may be because the context has changed such that no available message have selection criteria that are all fulfilled by the current context, or it may be that there is some technical incompatibility between the main AR app 301, or other AR content loaded by the main AR app 301, and the available external AR messages.

Since there may be several reasons why the external AR message selected in step 505 is not a complete match with respect to all criteria, it is determined in step 506 whether the selected message can still be handled by the main AR app 301. What this means is that the available metadata describing the selected external AR message is sufficient for the AR app module to conclude that the AR content integrator module 306 will be able to position the selected external AR message in the AR environment such that the AR renderer 307 can render the scene with the external AR message in a satisfactory manner.

This determination is made by comparing available metadata for the selected AR message with available information about capabilities and requirements of the main AR app, given context including other loaded AR content.

If it is determined in step 506 that the main AR app 301 can handle the selected external AR message the process moves to step 504 where the message is forwarded to the main AR app 301.

If, however, it is determined in step 506 that the main AR app 301 will not be able to handle the selected message the process moves to step 507. In step 507 the AR app module 302 runs its own surface detection function (or, in some embodiments, its own image recognition function) in order to generate the necessary metadata for integration of the message into the AR environment. This metadata may include positioning information and possibly also other information related to rendering.

In step 508 the generated metadata is embedded in or otherwise associated with the selected external AR message in order to create a message that the main AR app 301 will be able to handle. The process then moves to step 504 where the modified message is forwarded to the AR content integrator 306 in the main AR app 301.

When the process reaches step 509 the AR content integration module 306 has received an external AR message it should be able to integrate into the AR environment, and integration is performed. The updated AR environment is then forwarded to the AR rendering module 307 where it is rendered to the display of the device 202.

The above description has not gone into detail with respect to how surface detection or image recognition is performed, since these are technologies that are well known in the art. Similarly, it is well known how to integrate AR elements into an AR environment provided that all necessary parameters are available. In most situations the AR elements are developed in order to be integrated into an AR environment by software with capabilities that are already known. The present invention addresses the situation where external AR messages are created independently of the software in which it will be integrated and rendered, and the ability to perform this integration can be distributed to an unlimited number of different apps that may vary wildly in capabilities and purpose. The present invention makes it possible for the various apps to make their capabilities known to an integrated module that partly functions as a frontend for an ecosystem of external AR content such that compatible content can be selected, and partly functions as middleware that is capable of modifying AR content that is not fully compatible such that it becomes fully compatible.

Fully compatible in this context means that the main AR app 301 is able to integrate and render the external message. The relevance of external AR messages to the main AR content may vary, and the extent to which it is experienced as a natural part of the AR environment by a user may also vary.

As already mentioned, the external AR message service 304 selects external AR messages from a database 204. This database is typically a repository of AR messages that have been developed as such and that includes required metadata not only related to selection criteria, but also with respect to technical criteria for integration into an AR environment. However, the database 204 may also include, or the AR message service 304 may also communicate with other databases that include, messages that have been developed for presentation in traditional 2D environments. Such messages may for example be 2D images or 2D videos. Such external messages may also be handled by the present invention. In particular, 2D messages may be modified by an AR creator module which may be part of the AR message service 304. An AR creator module may also be implemented on a computer 201 where external AR message content may be created from other media types.

The AR creator module is a tool that performs a method of converting media content into AR content, and in particular into external AR messages that can be managed and presented in accordance with the aspects of the invention described above. The module is a software and hardware combination that is configured to perform a method that takes media content as input and provides AR content as output.

Some embodiments of the AR creator module are configured to accept traditional 2D messages, for example text, images, or video, from a repository of messages such as advertisements and announcements and convert them to a format that is prepared for integration into an AR environment as external AR messages. Such a module may be integrated into or operating in association with the AR message service 304 and the database 204. The module may then be configured to receive traditional 2D messages, convert them, and store them in the database so they can be selected and provided to users in accordance with the description above.

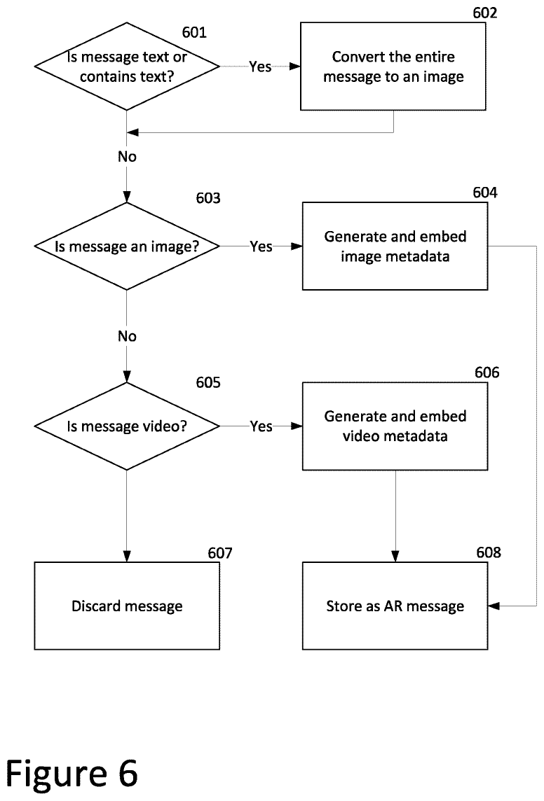

Whether the AR creator module is configured to operate as an automatic converter of non-AR content into content ready for AR integration in a server environment or provided as part of a tool on a computer 201 operated by a designer, certain steps performed are essentially the same. FIG. 6 shows a flowchart illustrating how this method may be performed. Again it should be understood that the sequence of steps shown in the drawing and described below are chosen in order to facilitate explanation of certain features, but that an embodiment operating on an actual device may perform steps in parallel, include decision points that are not simply binary, etc. Similarly, terms like first, second, and next should be understood as intended to differentiate between different functions, not as indicating a strict sequence.

The embodiment illustrated in FIG. 6 is initiated when a message is received. In a first step 601 it is determined whether the message is or contains text. If this is the case the process moves to step 602 where the entire message is converted to an image. If the message was only text this may be done by virtually rendering the text in memory and converting the rendered text to an image format, for example jpg or png. If the message is an image what also includes text, the text may for example be converted to a layer in the image and the image may subsequently be flattened into one layer.

If the message did not contain text processing progresses from step 601 to step 603, which is also the next step after step 602. In step 603 it is determined if the message is an image. If the message is determined to be an image, which will be the case if it was converted to an image in step 602 or if it was delivered as an image when it was first received by the AR content creation module, the process moves to step 604. In step 604 necessary metadata is created. The metadata may include selection criteria, but also additional information related to the AR integration. For example, the metadata may indicate that the image should be positioned on a surface detected in the AR environment using surface detection, it may specify size, dimensions, resolution, duration of display, and possibly other information. After the information necessary for AR integration has been added the image may be stored in the database 204 as an external AR message in step 608.

If it is determined in step 603 that the message is not an image, processing moves to step 605 where it is determined if the message is a video. If it is determined to be a video, processing moves to step 606 which generates and embeds video metadata in a process similar to the one for images, except that the metadata may include other parameters.

When necessary, metadata has been embedded in the message the message can be stored in the database 204 in step 608.

Finally, if it is determined that the message is not a video, processing may move to step 607 where the message is discarded because it cannot be converted to an external AR message.

The description above does not mention additional media such as for example audio or haptics. The invention may, of course, be modified to be able to handle content where such additional information is included together with the image or video. Also, while the ability to handle text, images, and video, possibly in combination with audio or haptics, may be sufficient for conversion of traditional 2D messages, an AR creation module installed as a tool on a computer operated by a designer may include additional functionality, for example the ability to add AR related metadata to 3D objects.

Finally, the AR creator module may include certain additional features such as natural language processing, and image recognition. Such features may be used to generate additional information from the message either to be included as metadata describing the content, to modify selection criteria, or in order to generate 3D AR content for a richer and more natural user experience. For example, if the message is an image of a running shoe, the image recognition algorithm may identify it as such and a 3D shoe model can be automatically generated. This way, the ecosystem can convert at least some 2D or textual ads into 3D ads and enhance the user experience.

1. A method in a computing device of providing an external message in an augmented reality environment, comprising:
receiving the external message including metadata relating to the desired presentation of the external message in the augmented reality environment;
integrating the external message into the augmented reality environment based on a comparison of characteristics of the augmented reality environment with the metadata relating to the desired presentation of the external message in the augmented reality environment; and
rendering the augmented reality environment with the external message integrated into the augmented reality environment;
wherein:
the metadata relating to the presentation of the external message in the augmented reality environment includes technical criteria for integration of the external message into the augmented reality environment; and
the metadata relating to the presentation of the external message is evaluated for completeness with respect to integration (502), and if it is determined that the metadata is incomplete, determining whether the available metadata is sufficient for integration, and
if the available metadata is sufficient for integration, integrating the external message into the augmented reality environment based on the available information, and
if the available metadata is insufficient for integration, integrating the external message into the augmented reality environment based on a process of surface detection (507) in the augmented reality environment and integration of the external message in conjunction with a detected surface in the augmented reality environment.

2. A method according to claim 1, wherein the technical criteria for integration specifies at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment.

3. A method according to claim 1, further comprising transmitting context information to a remote message server (403), and wherein:
the step of receiving the external message includes receiving a set of messages (405) that have been selected based on a comparison of the transmitted context information with selection criteria associated with the respective external messages and adding the received messages to local storage.

4. A method according to claim 3, wherein the external message is selected from the set of messages based on prioritization according to a predetermined scoring system for prioritization of messages (501).

5. A method according to claim 1, wherein the metadata relating to the presentation of the external message in the augmented reality environment includes selection criteria specifying at least one of information about loaded augmented reality content, a feature detected in the augmented reality environment, a device location, and a user demographic.

6. A method in a server of generating an external message that may be integrated into an augmented reality environment, comprising:
determining if the message is pure text (601), and if it is, converting the text to an image (602);
determining if the message is an image (603), and if it is, generating and embedding metadata describing how the image should be integrated into an augmented reality environment (604);
determining if the message is a video (605), and if it is, generating and embedding metadata describing how the image should be integrated into an augmented reality environment (606); and
storing or transmitting the message as an external augmented reality message (608).

7. A method according to claim 6, wherein the metadata describing how the image should be integrated into an augmented reality environment includes technical criteria specifying at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment.

8. A method according to claim 6, further comprising embedding metadata relating to the selection of the external message for integration in the augmented reality environment, including selection criteria specifying at least one of information about loaded augmented reality content, a feature detected in the augmented reality environment, a device location, and a user demographic.

9. A device (202) configured to present an augmented reality environment and including an augmented reality app module (302) configured to receive external messages, a camera module (305) configured to receive image information relating to a local scene from a device camera, and an augmented reality content integration module (306) configured to create an augmented reality environment by receiving and integrating images from the camera module (305), main augmented reality content from local memory, and external messages from the augmented reality app module (302);
wherein:
the augmented reality integration module (306) is configured to integrate the external messages into the augmented reality environment based on metadata associated with the respective messages and including technical criteria for integration of the external message into the augmented reality environment; and
the augmented reality app module (302) is configured to evaluate the metadata relating to the presentation of the external message for completeness with respect to integration (502), and if it determines that the metadata is incomplete, to determine whether the available metadata is sufficient for integration, and
if the available metadata is sufficient for integration, to integrate the external message into the augmented reality environment based on the available information, and
if the available metadata is insufficient for integration, to integrate the external message into the augmented reality environment based on a process of surface detection (507) in the augmented reality environment and integration of the external message in conjunction with a detected surface in the augmented reality environment.

10. A device (202) according to claim 9, wherein the technical criteria for integration specifies at least one of the absolute position of the external message in the augmented reality environment, the position of the external message in the augmented reality environment relative to another object in the augmented reality environment, that the external message should be positioned on a surface in the augmented reality environment, and that the external message should be positioned on or near a specific object or type of object in the augmented reality environment.

11. A device (202) according to claim 9, further configured to receive main augmented reality content from an augmented reality content service (303) and external messages from a message service (304).
